(19) United States
(12) Patent Application Publication
(10) Pub. No.: US 2013/0049530 A1
(43) Pub. Date: Feb. 28, 2013

(54) DIELECTRIC ELASTOMER COMPOSITES AND ACTUATORS USING THE SAME

(71) Applicants: Chong Min Koo, Gyeonggi-do (KR); Soon Man Hong, Seoul (KR); Seung Sang Hwang, Seoul (KR); Kyung Youl Baek, Seoul (KR); Soon Jong Kwak, Seoul (KR); Myung Hee Kim, Seoul (KR); Bo Ri Kim, Seoul (KR); Hee La Kwak, Seoul (KR); Kyung Ho Min, Chungcheongbuk-do (KR); Youn Duk Park, Seoul (KR)

(72) Inventors: Chong Min Koo, Gyeonggi-do (KR); Soon Man Hong, Seoul (KR); Seung Sang Hwang, Seoul (KR); Kyung Youl Baek, Seoul (KR); Soon Jong Kwak, Seoul (KR); Myung Hee Kim, Seoul (KR); Bo Ri Kim, Seoul (KR); Hee La Kwak, Seoul (KR); Kyung Ho Min, Chungcheongbuk-do (KR); Youn Duk Park, Seoul (KR)

(73) Assignee: KOREA INSTITUTE OF SCIENCE AND TECHNOLOGY, Seoul (KR)

(21) Appl. No.: 13/643,774

(22) PCT Filed: Aug. 24, 2010
(86) PCT No.: PCT/KR10/05636

§ 371 Date: Oct. 26, 2012

(30) Foreign Application Priority Data
Apr. 27, 2010 (KR) 10-2010-0038894

(51) Int. Cl. H02N 11/00; B05D 5/12; B82Y 99/00

(52) U.S. Cl. 310/300; 427/58; 977/932

(57) ABSTRACT

The present invention relates to an actuator which is one of the energy conversion devices, and is characterized by improving the ability to convert electrical energy into mechanical energy by way of using a dielectric elastomer composite comprising a filler with an efficient dispersibility. In case of using a conventional resilient dielectric layer, there was a problem in that the operating voltage is high, while advantageously exhibiting a fast response and a high strain. The present invention can provide dielectric elastomer composite actuators that show excellent electromechanical conversion properties, by adding a dispersing agent such as a pyrene derivative or a polymeric compound having an amine end group when preparing the composite wherein carbon-based conductive fillers such as carbon blacks, single-walled carbon nanotubes (SWCNTs), double-walled carbon nanotubes (DWCNTs), multi-walled carbon nanotubes (MWCNTs) and graphenes, or high dielectric fillers such as copper phthalo-cyanine (CuPc), MOFs (metal organic frameworks) and barium titanate (BaTiO₃) are comprised in a thermoplastic resilient dielectric layer to enhance the dispersibility of the fillers.

### TECHNICAL FIELD

The present invention generally relates to dielectric elastomer composite actuators that convert electrical energy into mechanical energy, and more particularly to polymer composite actuators with enhanced electromechanical convertibility of the dielectric elastomer composites by including fillers having an effective dispersibility.

### BACKGROUND ART

Conventional devices (electromechanical devices) that convert electrical energy into mechanical energy and capable of being used in robotics, pumps, speakers, disc drives, camera lenses, etc. have used piezoelectric ceramic materials, but have disadvantages such as low mechanical strain, high brittleness and high manufacturing cost. In order to overcome such drawbacks, there have been a great deal of research on technologies that can substitute the above piezoelectric ceramic materials with polymers. Recently, actuators using elastomers with dielectric properties like acrylic rubber, silicone rubber, acrylonitrilbutadiene rubber (NBR), and styrene-b-ethylbutylene-b-styrene (SEBS) have been actively studied.

Actuators using resilient dielectric layers as above have advantages such as having a very high speed of converting electrical energy into mechanical energy and high strain value, but are problematic in that their operating voltage is very high. Thus, studies in order to overcome the above problems have been carried out. The operation of actuators using resilient dielectrics is performed according to Maxwell stress σ (where σ=ε₀εE² and εₒ, ε and E represent the permittivity under vacuum, dielectric constant and electric field strength, respectively). Maxwell stress is proportional to the dielectric constant and the square of the electric field.

Japanese Patent Publication Nos. 2008-239929 and 2005-177003 disclose enhancing electromechanical conversion efficiency by adding a ceramic filler including lithium to a thermoplastic elastomer to increase the dielectric constant with a low cost. PCT International Patent Publication No. WO 98/040435 discloses an actuator using a composite having conductive fillers such as carbon black, graphites, metal particles added to a resilient elastomer.

In the above-mentioned conventional techniques, however, there are limitations in enhancing the electromechanical conversion efficiency, because the dispersed phase of the fillers is formed in a dispersed phase size of micrometer level while the formation of the aggregates of fillers leads to the formation of conduction pass, resulting in di-electric loss. Thus, there was a disadvantage in that, when fillers were added, the di-electric loss and leakage current increased and the breakdown strength became poor (see U.S. Pat. No. 6,909,220 and PCT International Patent Publication No. WO 98/040435, etc.).

Accordingly, the inventors arrived at the present invention by finding that dielectric elastomer composite actuators having excellent electromechanical operation properties can be provided, when, in a resilient dielectric layer, fillers are dispersed at the molecular level and their surfaces are subject to passivation.

### DISCLOSURE OF INVENTION

### Technical Problem

The present invention relates to preparing a composite by adding conductive or semi-conductive fillers with high dispersibility to a resilient elastomer and providing a di-electric elastomer composite actuator which has excellent electromechanical properties by using the same.

### Solution to Problem

In accordance with one aspect of the present invention, there is provided an actuator, comprising:

a resilient dielectric layer comprising a polymer composite that comprises a resilient elastomer having a polar group, one or more conductive or high dielectric fillers, and optionally, a dispersing agent;

an upper electrode attached to one side of the resilient dielectric layer; and

a lower electrode attached to the opposite side of the resilient dielectric layer to which the upper electrode is attached.

In accordance with another aspect of the present invention, there is provided a method for preparing the above actuator, comprising:

mixing a resilient elastomer having a polar group, one or more conductive or high di-electric fillers, and optionally, a dispersing agent;

treating the obtained mixture by one or more processes selected from the group consisting of ultrasonic treatment, ball milling, and mixing by a mixer;

molding the obtained mixture to form a resilient dielectric layer; and

forming an upper electrode and a lower electrode on both sides of the resilient di-electric layer.

### Advantageous Effects of Invention

According to the present invention, the electromechanical properties of a polymer composite actuator may be improved by using a compound having an amine end group or a pyrene derivative as a dispersing agent in order to improve the dispersibility of the fillers in the polymer matrix of a polymer composite actuator to which conductive fillers or semi-conductive fillers having a high dielectric constant are added. In particular, in order to improve the dispersibility of the fillers, elastomers comprising maleic anhydride, acrylic, urethane, carboxylic or amine group may be used as a polymer matrix, allowing the electromechanical properties of a polymer composite actuator to be highly enhanced.

### BRIEF DESCRIPTION OF DRAWINGS

The above and other objects and features of the present invention will become apparent from the following description of illustrative embodiments provided in conjunction with the accompanying drawings.

FIG. 1 is a schematic diagram depicting the operation principle of an actuator in accordance with the present invention.

FIG. 2 is a schematic diagram showing a mixture comprising the resilient dielectric layer and a process which enhances the efficiency in dispersion by ball milling during the process for preparing an actuator in accordance with the present invention.

FIG. 3 is a schematic diagram showing the step in which carbon electrodes are applied to upper/lower electrodes during the process for preparing an actuator in accordance with the present invention.

FIG. 4 is a schematic diagram depicting an apparatus for measuring the electromechanical strain response of the actuator in accordance with the present invention in converting electrical energy into mechanical energy.

FIG. 5 is a graph showing electromechanical strain values of the actuators in accordance with Examples 1-3 and Comparative Examples 1 and 2.

FIG. 6 is a schematic diagram depicting how dispersing agents such as (a) pyrene derivative and (b) amine terminated polystyrene help to increase dispersibilty of the carbon nanotubes in a polymer matrix.

### DESCRIPTION OF LEGENDS IN THE DRAWINGS

2a: sonication
2b: ball milling
3a: resilient dielectric layer
3b: upper electrode plane
3b′: lower electrode plane

### BEST MODE FOR CARRYING OUT THE INVENTION

In one embodiment of the present invention, the resilient elastomer may be one or more selected from the group consisting of a thermoplastic elastomer having at least one functional groups selected from the group consisting of maleic anhydride, acrylic, urethane, carboxylic and amine groups, copolymers and block copolymers thereof.

In another embodiment of the present invention, the conductive or high dielectric filler may be one or more selected from the group consisting of carbon black, single-walled carbon nanotube (SWCNT), double-walled carbon nanotube (DWCNT), multi-walled carbon nanotube (MWCNT) and graphene, where it may be used in an amount ranging from 0.01 to 20 weight %, specifically from 0.1 to 10 weight %, most specifically from 1 to 5 weight %, based on the weight of the polymer composite. In this case, the resilient elastomer may be used in an amount ranging from 80 to 99.99 weight %, specifically from 90 to 99.9 weight %, most specifically from 95 to 99 weight %, based on the weight of the polymer composite.

In another embodiment of the present invention, the conductive or high dielectric filler may be one or more selected from the group consisting of copper phthalocyanine (CuPc), barium titanate (BaTiO₃) and MOF (metal organic framework) organometallic compound, where it may be used in an amount ranging from 1 to 70 weight %, specifically from 5 to 50 weight %, most specifically from 10 to 30 weight %, based on the weight of the polymer composite. In this case, the resilient elastomer may be used in an amount ranging from 30 to 99 weight %, specifically from 50 to 95 weight %, most specifically from 70 to 90 weight %, based on the weight of the polymer composite.

In another embodiment of the present invention, the polymer composite may comprise a dispersing agent. The dispersing agent may be a pyrene derivative, particularly a pyrene derivative with an aliphatic chain having 4 to 20 carbon atoms or comprising an acrylic, urethane or polystyrene oligomer having a molecular weight of 5000 or less, or a polymeric compound having an amine end group. The content of the dispersing agent may be in the range of from 0 to 30 weight %, specifically from 0.1 to 3 weight %, based on the weight of the polymer composite.

The present invention also relates to a method for preparing an actuator using a polymer composite, which exhibits an enhanced strain value at low voltage, where the method involves:

mixing a resilient elastomer having a polar group, one or more conductive or high di-electric fillers, and optionally, a dispersing agent;

treating the obtained mixture by one or more processes selected from the group consisting of ultrasonic treatment, ball milling, and mixing by a mixer;

molding the obtained mixture to form a resilient dielectric layer; and

forming an upper electrode and a lower electrode on both sides of the resilient di-electric layer.

The present invention is described in detail below.

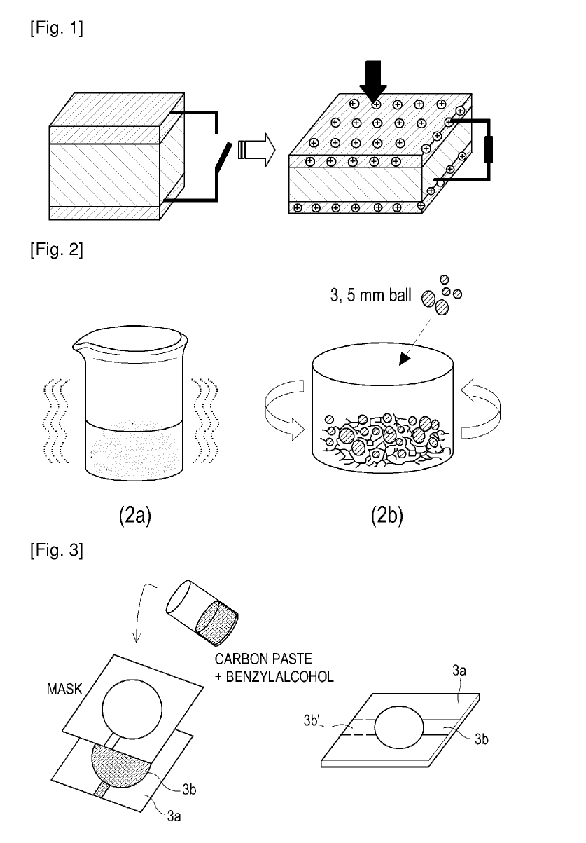

As shown in FIG. 1, the actuator comprising a resilient dielectric layer with a elastomer matrix which is an insulator and upper/lower electrodes, exhibits an actuation behavior of contracting in the thickness direction and expanding in the plane direction, when a voltage is applied to the upper and lower electrodes. While the above actuator has the advantages of fast response and high strain value, the high operating voltage is a drawback.

Accordingly, the present inventors have endeavored to develop a dielectric elastomer composite to show enhanced strain at a lower voltage. In particular, the present inventors have developed a polymer composite actuator capable of achieving a high strain value by adding a filler including a carbon-based filler, such as carbon black, carbon nanotube, graphene, etc., a ceramic-based filler or a semi-conductive filler to the resilient elastomer matrix, which allows the fillers at the matrix interface to improve the electromechanical response properties of the actuators within the percolation threshold value.

In conventional techniques, flexible thermoplastic elastomers, such as acrylic rubber, silicone rubber, NBR (nitrobutadiene rubber), SEBS (styrene-b-ethylbutylene-b-styrene), etc., have been used as an insulating elastomer matrix. In particular, it has been reported that SEBS has high tensile strength and high strain under elongated conditions, rendering it suitable for use in artificial muscles (see U.S. Pat. No. 6,909,220). In the present invention, in order to obtain a higher strain, SEBS-g-MA (styrene-b-ethylbutylene-b-styrene grafted maleic anhydride) where maleic anhydride is grafted or resilient insulating elastomers having an acrylic group may be used to induce higher strain value due to the increase in the contribution of polarization by a polar group. Also, copolymers having a polar group such as an amine or carboxylic group may obtain a higher strain value, as compared with the copolymers having no such polar groups.

Therefore, a dielectric elastomer composite capable of achieving higher strain even at a lower content may be prepared by efficiently dispersing carbon-based fillers such as carbon blacks, carbon nanotubes, graphenes, etc., ceramic fillers or semi-conductive fillers into an insulating elastomer matrix with a polar group.

In order to efficiently disperse the fillers to molecular size, a dispersion aid may be used. A pyrene derivative or a compound having an amine end group may be added as a dispersing agent to cause the passivation of the filler surfaces. This results in the improvement of dispersibility of the fillers and the prevention of agglomeration between the fillers. Further, when mixing the fillers with the matrix, ultrasonic treatment (ultrasonication), ball-milling or a mixer may be used to enhance the dispersibility of the fillers in the matrix, thereby making it possible to prepare a dielectric elastomer composite actuator which has stability as well as high strain without any decrease in breakdown strength at a lower filler content.

The present invention is further described and illustrated in the Examples provided below. However, it should be expressly noted herein that the Examples are not intended to limit the scope of the present invention.

### Example 1

Styrene-ethylbutylene-styrene-g-maleic anhydride (SEBS-g-MA) copolymer (Trade

Name: FG1901X) having a polar group and provided by Kraton Polymers LLC was used as the resilient dielectric layer (3a). In order to impart plasticization, paraffin-based oil (T-150) purchased from Michang Oil Industry Co. LTD, was added thereto. The copolymer and oil were combined at a content ratio of 20 weight %: 80 weight %. Based on the matrix content, 0.05 weight % of the fillers, single-walled carbon nanotubes (SWCNT, AST-100F) provided by Hanwha Nanotech Co., were subjected to sufficient sonication (2a) with the addition of toluene. Thereafter, ball-milling using a zirconium ball (2b) was performed in a slurry state at 400 rpm for 3 hours. In order to prepare a sample as shown in FIG. 3a, a 7-ton force was applied thereto at 100° C. by compression molding to obtain a resilient dielectric layer of 60×60×0.5 mm³. When forming the upper electrode plane (3b) and the lower electrode plane (3b′), the spin coating method was performed by pouring a solution in which a carbon paste was dissolved in benzyl alcohol to give a uniform thickness. 5 g of the carbon paste, FTU-60N4-20, which was provided by Asahi Chemical Research Laboratory Co., was mixed with 3 ml of benzyl alcohol to obtain a solution of a suitable concentration. The obtained solution was used to apply carbon electrodes onto the upper electrode plane (3b) and the lower electrode plane (3b′), as shown in FIG. 3.

### Example 2

In the resilient insulating elastomer matrix, the weight ratio of styrene-ethylenebutylene-styrene comprising maleic anhydride (SEBS-g-MA) to the oil was fixed to 20 weight %: 80 weight %, as described in Example 2. As shown in FIG. 2a, based on the matrix content, 0.05 weight % of the fillers, single-walled carbon nanotubes (SWCNT, AST-100F) provided by Hanwha Nanotech Co., were added thereto and subjected to ultrasonic treatment for a sufficient time with the addition of toluene and 0.1 weight % of the pyrene derivative, N-hexadecylpyrene-1-sulfonamide (Aldrich), which is a dispersion agent. As shown in FIG. 2b, the above mixture was well sonicated with SEBS-g-MA copolymer swelled in paraffin-based oil in a bowl, followed by ball-milling using a zirconium ball in a slurry state for 3 hours with the addition of fillers comprising N-hexadecylpyrene-1-sulfonamide.

The processes for forming a resilient dielectric layer (3a) and upper/lower electrodes (3b) were carried out as described in Example 1.

### Example 3

A resilient insulating elastomer matrix (FIG. 3a) as described in Example 1 was used. 30 weight % of copper phthalocyanine (CuPc) was added thereto as a filler to prepare a dielectric elastomer composite. In order to facilitate the dispersion of the fillers, ultrasonic treatment was performed with the addition of 0.1 weight % of polystyrene having an amine end group which is a dispersing agent for improving the dispersibility of the fillers. SEBS-g-MA, paraffin-based oil, and CuPc comprising polystyrene that has an amine end group were added to the bowl, and toluene was used as a solvent. A zirconium ball was put into the bowl where ball-milling was performed for 3 hours while maintaining the speed at 400 rpm. After the ball-milling was finished, the processes for forming a resilient dielectric layer (3a) and upper/lower electrodes (3b) were carried out as described in Example 1.

### Comparative Example 1

Styrene-ethylbutylene-styrene (SEBS) copolymer (Trade Name: G1650M, molecular weight: 110,000) which was purchased from Kraton Polymers LLC was used as a resilient dielectric layer (3a). In order to impart plasticization, paraffin-based oil (T-150), which was purchased from Michang Oil Industry Co. LTD., was added thereto, allowing the copolymer to be swelled. The content ratio of the copolymer to the oil was 20 weight %: 80 weight % as in the above Examples. Based on the matrix content, 0.05 weight % of the fillers, single-walled carbon nanotubes (SWCNT), which are the same materials as used in the above Examples, were added thereto and subjected to ultrasonic treatment (2a), followed by ball-milling (2b) with 3 mm and 5 mm zirconium balls in a slurry state at 400 rpm for 3 hours. Thereafter, the processes for forming a resilient dielectric layer and upper/lower electrodes were carried out as described in Example 1. In order to prepare a sample as shown in FIG. 3a, a 7-ton force was applied thereto at 100° C. by compression molding as described in the above Examples, to obtain a resilient dielectric layer of 60×60×0.5 mm³. Also, in order to coat the upper electrode plane (3b) and the lower electrode plane (3b′), the spin coating method was performed by using a solution of a suitable concentration in which 5 g of the carbon paste, FTU-60N4-20, which was provided by Asahi Chemical Research Laboratory Co., and 3 ml of benzyl alcohol were mixed.

### Comparative Example 2

SEBS and copper phthalocyanine (CuPc) were used as material constituting a resilient dielectric layer (3a) and a filler, respectively. The SEBS which was swelled with the addition of paraffin-based oil in the same content ratio as described in Example 1, and 30 weight % of CuPc were added and subjected to ultrasonic treatment (2a), followed by ball-milling (2b) with 3 mm and 5 mm zirconium balls in a slurry state at 400 rpm for 3 hours. Thereafter, the processes for forming a resilient dielectric layer and upper/lower electrodes were carried out as described in Example 1.

(Electromechanical Response Behavior Test for Dielectric Elastomer Composites)

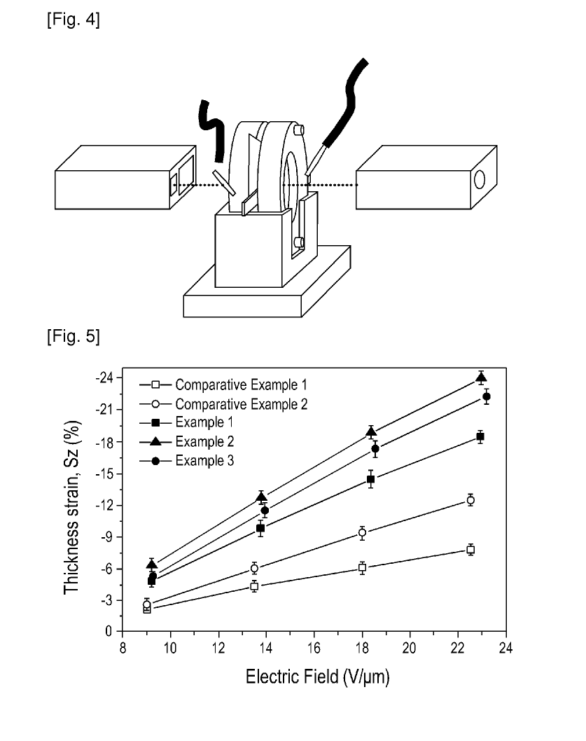

In order to obtain the strain value of contracting in the thickness direction when a voltage is applied (thickness strain, Sz), which is a measure for the ability to convert electrical energy into mechanical energy, the strain values due to the electromechanical responses of the polymer composite actuators were measured via two laser sensings with application of a voltage, as shown in FIG. 4. The strain values were obtained by the following equation.

<Math FIG. 1>

Sz (%)=t/tₒ*100

(wherein t and tₒ are the thicknesses of the samples before and after applying a voltage, respectively)

(The Strain Value Results for Examples 1, 2 and 3, and Comparative Examples 1 and 2)

In FIG. 5, the strain values of contracting in the thickness direction (thickness strain, Sz), which are measures for actuation behavioral ability of the resilient dielectric layers according to Examples 1-3 and Comparative Examples 1 and 2 to contract in the thickness direction due to the conversion of electrical energy into mechanical energy when a voltage is applied, were shown.

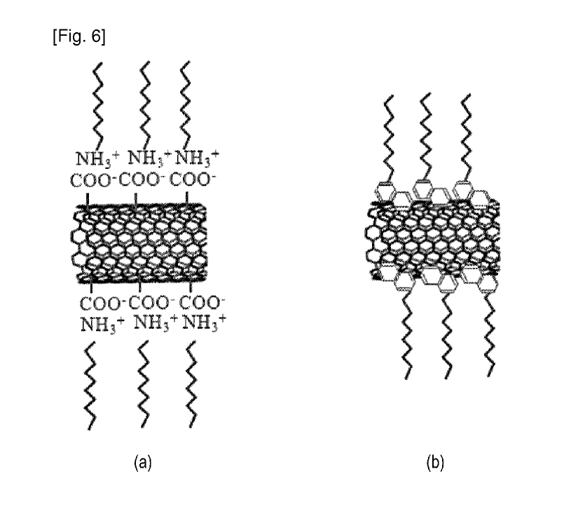

Example 1 and Comparative Example 1 reveal the effect of the resilient dielectric layer (3a) on the electromechanical properties when the same fillers are added in the same amount. As compared with Comparative Example 1, Example 1 (SEBS-g-MA), where the matrix of Comparative Example 1 (SEBS) is grafted with a polar maleic anhydride group, shows a higher strain value due to the increase in the contribution of polarization by the polar group when a voltage is applied. When comparing Example 2 with Example 1, it is shown that the dispersing agent plays an important role in improving the electromechanical properties. In Example 2, at least a 3 times higher strain value was achieved by adding at least 0.1 weight % of N-hexade-cylpyrene-1-sulfonamide which is a pyrene derivative. That is, adding a pyrene derivative as a dispersing agent can impart the dielectric elastomer composite with the properties capable of obtaining a high strain even at a low filler content due to the dispersion effect, as shown in FIG. 6. Specifically, (a) pyrene derivative and (b) amine terminated polystyrene are adsorbed on the surface of carbon nanotubes in terms of secondary interactions such as p-p interaction and hydrogen-bond, respectively. Further, a comparison of Example 3 with Comparative Example 2 reveals that using a polystyrene having an amine end group as a dispersing agent can also give the same effect as above, and thus, it can provide a high strain value due to the increase in dispersion. When compared with the dispersion of CuPc by simple mixing and ball-milling, surface passivation of CuPc with a polystyrene having an amine end group can more efficiently disperse the filler to the maximum without aggregation to enhance the dielectric property. Further, since CuPc is a semi-conductive filler, it can give a di-electric elastomer composite that has a stability without decreasing the breakdown strength, even when added in large amounts. Besides CuPc, adding a ceramic filler such as MOF (Metal Organic Framework) which is a metal-organic mixture, barium titanate (BaTiO₃), etc. also can have the same effect as above, thereby providing enhanced electromechanical properties. Therefore, the resilient dielectric composite in which conductive or semi-conductive fillers are dispersed with a dispersing agent in a matrix having a polar group exhibits an improved electromechanical convertibility.

### INDUSTRIAL APPLICABILITY

The present invention provides electroactive polymer composites in which various fillers with the increased dispersibility are incorporated, and may be efficiently applicable to the field for which the polymer actuators using composites are used. It can be advantageously used for speaker panels, acoustic actuators, robot arms, and has an effect that high strain can be obtained at a low voltage by adding fillers to give enhanced electromechanical properties.

While the embodiments of the subject invention have been described and illustrated, it is obvious that various changes and modifications can be made therein without departing from the spirit of the present invention which should be limited only by the scope of the appended claims.

1. An actuator comprising:
a resilient dielectric layer comprising a polymer composite that comprises a resilient elastomer having a polar group, and one or more conductive or high dielectric fillers;
an upper electrode attached to one side of the resilient dielectric layer; and
a lower electrode attached to the opposite side of the resilient dielectric layer to which the upper electrode is attached.

2. The actuator of claim 1, wherein the resilient elastomer is one or more selected from the group consisting of a thermoplastic elastomer having at least one functional groups selected from the group consisting of maleic anhydride, acrylic, urethane, carboxylic and amine groups, and copolymers and block copolymers thereof.

3. The actuator of claim 1, which contains one or more selected from the group consisting of carbon blacks, single-walled carbon nanotubes (SWCNT), double-walled carbon nanotubes (DWCNT), muti-walled carbon nanotubes (MWCNT) and graphenes in an amount ranging from 0.01 weight % to 20 weight %, based on the weight of the polymer composite, as the conductive or high dielectric fillers.

4. The actuator of claim 1, which contains one or more selected from the group consisting of copper phthalocyanine (CuPc), barium titanate (BaTiO₃) and MOF (metal organic framework) organometallic compound, as the high dielectric filler, in an amount ranging from 1 weight % to 70 weight %, based on the weight of the polymer composite.

5. The actuator of claim 1, wherein the resilient dielectric layer further comprises a dispersing agent.

6. The actuator of claim 5, wherein the dispersing agent is a pyrene derivative or a polymeric compound having an amine end group.

7. The actuator of claim 6, wherein the pyrene derivative has an aliphatic chain having 4 to 20 carbon atoms, or comprises an acrylic, urethane or polystyrene oligomer having a molecular weight of 5000 or less.

8. A method for preparing an actuator, comprising:
mixing a resilient elastomer having a polar group, one or more conductive or high dielectric fillers, and optionally, a dispersing agent;
treating the obtained mixture by one or more processes selected from the group consisting of ultrasonic treatment, ball milling, and mixing using a mixer;
molding the obtained mixture to form a resilient dielectric layer; and
forming an upper and lower electrodes on both sides of the resilient di-electric layer.
